(19) United States
(12) Patent Application Publication
(10) Pub. No.: US 2026/0061842 A1
(43) Pub. Date: Mar. 5, 2026

(54) ADAPTIVE RANKING AND VISUALIZATION OF NON-URGENT NOTIFICATION MESSAGES FOR VEHICLE ENVIRONMENTAL CONDITIONS

(71) Applicant: GM GLOBAL TECHNOLOGY OPERATIONS LLC, Detroit, MI (US)

(72) Inventors: Sycamore ZHANG, Shanghai (CN); Omer TSIMHONI, Bloomfield Hills, MI (US); Joseph F. SZCZERBA, Grand Blanc, MI (US)

(21) Appl. No.: 18/923,768

(22) Filed: Oct. 23, 2024

(30) Foreign Application Priority Data
Sep. 5, 2024 (CN) 2024112423956

(51) Int. Cl. B60K 35/22; B60K 35/25; B60K 35/26

(52) U.S. Cl. CPC B60K 35/22; B60K 35/25; B60K 35/26

(57) ABSTRACT

An assisted driving system includes: inputs configured to receive sensor data, telematics data, and driver response data; an assisted driving module configured to, based on the sensor data and telematics data generate first non-urgent notification messages; and a ranking module configured to rank the first non-urgent notification messages based on the driver response data. The assisted driving module is configured, based on the ranking of the first non-urgent notification messages, to output via at least one output device the first non-urgent notification messages such that saliency of each of the first non-urgent notification messages is based on the respective ranking of that non-urgent notification message.

### CROSS-REFERENCE TO RELATED APPLICATIONS

This application claims the benefit of Chinese Patent Application No. 202411242395.6, filed on Sep. 5, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to assisted and automated driving systems.

A driver of a vehicle traditionally views surroundings of the vehicle through windows, windshields, and other glass of the vehicle. The driver may control vehicle acceleration, deceleration, and steering based on the driver's visual observation of the surroundings of the vehicle. The vehicle may include one or more displays that display various information to the driver. For example, some vehicles include an infotainment system that includes a display that displays various infotainment and other vehicle information. The vehicle may also include a head-up display (HUD) that displays information by forming a virtual image at a certain distance forward of a windshield and with reflection of the windshield. For example, the HUD may display a vehicle speed and other vehicle information (e.g., warnings such as lane departure warnings and collision avoidance warnings).

Vehicles can have assisted and automated driving systems, which are implemented to aid a driver or vehicle occupant in driving a vehicle. As an example, a driver may be provided directions to a destination and/or provided with urgent alerts in the event of a potential collision. A vehicle can have a hands-free driving system that controls steering, braking, and accelerating operations during at least a portion of a trip. During hands-free driving, a driver is not controlling driving operations but may intervene should the driver disagree with an action being performed by the vehicle.

### SUMMARY

An assisted driving system is disclosed and includes: inputs configured to receive sensor data, telematics data, and driver response data; an assisted driving module configured to, based on the sensor data and telematics data generate first non-urgent notification messages; and a ranking module configured to rank the first non-urgent notification messages based on the driver response data. The assisted driving module is configured, based on the ranking of the first non-urgent notification messages, to output via at least one output device the first non-urgent notification messages such that saliency of each of the first non-urgent notification messages is based on the respective ranking of that non-urgent notification message.

In other features, the assisted driving module is configured to output a highest ranked one of the first non-urgent notification messages with a highest saliency and to output a lowest ranked one of the first non-urgent notification messages with a lowest saliency.

In other features, the ranking module is configured to: generate a respective risk mitigation metric and a respective advantage gaining metric for each of the first non-urgent notification messages; and rank the first non-urgent notification messages based on the risk mitigation metrics and the advantage gaining metrics.

In other features, the ranking module is configured to: generate a combined metric for each of the first non-urgent notification messages based on the respective risk mitigation metric and respective advantage gaining metric for that non-urgent notification message; and rank the first non-urgent notification messages based on the combined metrics.

In other features, each of the combined metrics is generated based on a weighted sum of the corresponding risk mitigation metric and advantage gaining metric.

In other features, each of the combined metrics is generated based on a weighted harmonic mean of the corresponding risk mitigation metric and advantage gaining metric.

In other features, the ranking module is configured to rank the first non-urgent notification messages based on at least one of i) driver responses to the first non-urgent notification messages, and ii) previous driver responses to other non-urgent notification messages.

In other features, the assisted driving system further includes an active learning module configured to actively learn driver preferences in outputting non-urgent notification messages based on driver responses to the first non-urgent notification messages. The assisted driving module is configured to output second non-urgent notification messages based on the driver preferences.

In other features, the assisted driving module is configured to generate and output a second non-urgent notification messages based on at least one of driver responses and lack of driver responses to the outputting of the first non-urgent notification messages.

In other features, the assisted driving module is configured to display the first non-urgent notification messages via displays.

In other features, the assisted driving module is configured to display a highest ranked one of the first non-urgent notification messages on a primary display and the other ones of the first non-urgent notification messages on a secondary display.

In other features, the assisted driving module is configured to determine which of the first non-urgent notification messages to display and at least one of i) not display a remainder of the first non-urgent notification messages, and ii) remove from memory the remainder of the first non-urgent notification messages.

In other features, the assisted driving module is configured to adjust saliency of the first non-urgent notification messages by adjusting at least one of a display order, colors, brightness levels, animation, blinking rates, locations, and sizes of the first non-urgent notification messages.

In other features, the assisted driving module is configured to re-rank at least one of the first non-urgent notification messages and a second non-urgent notification messages to modify which non-urgent notification messages are outputted for a driver and saliencies of each of the outputted non-urgent notification messages.

In other features, the telematics data includes vehicle-to-vehicle and cloud-based data.

In other features, the first non-urgent notification messages are outputted via at least one of a display, an audio device, and a haptic device.

In other features, an assisted driving method is disclosed and includes: receiving at an assisted driving module of host vehicle sensor data, telematics data, and driver response data; based on the host vehicle sensor data and telematics data, generating first non-urgent notification messages; ranking the first non-urgent notification messages based on the driver response data; and based on the ranking of the first non-urgent notification messages, outputting via at least one output device the first non-urgent notification messages such that saliency of each of the first non-urgent notification messages is based on the respective ranking of that non-urgent notification message.

In other features, the assisted driving method further includes: generating a respective risk mitigation metric and a respective advantage gaining metric for each of the first non-urgent notification messages; and ranking the first non-urgent notification messages based on the risk mitigation metrics and the advantage gaining metrics.

In other features, the assisted driving method further includes ranking the first non-urgent notification messages based on at least one of i) driver responses to the first non-urgent notification messages, and ii) previous driver responses to other non-urgent notification messages.

In other features, the assisted driving method further includes, based on the ranking of the first non-urgent notification messages, adjusting saliency of the first non-urgent notification messages by adjusting at least one of display order, color, brightness, animation, blinking rate, location, and size of the first non-urgent notification messages.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a host vehicle including an example advanced driver assistance system (ADAS) (or driver automation system (DAS)) with a driver monitoring system (DMS) and an assisted driving module including an adaptive alert module in accordance with the present disclosure;

FIG. 2 is a functional block diagram of an example communication system including the host vehicle in accordance with the present disclosure;

FIG. 3 is a perspective view of an example interior of a vehicle providing adaptive alerting of non-urgent messages in accordance with the present disclosure;

FIG. 4 is a perspective view of another example interior of a vehicle providing adaptive alerting of non-urgent messages in accordance with the present disclosure;

FIG. 5 illustrates a method of interacting with a vehicle driver including providing a detecting response to non-urgent notification messages in accordance with the present disclosure;

FIG. 6 illustrates a method of generating, updating, parsing, removing, and ranking non-urgent notification messages and providing ranked non-urgent notification messages to driver in accordance with the present disclosure; and

FIG. 7 illustrates a method of ranking non-urgent notification messages in accordance with the present disclosure.

In the drawings, reference numbers may be reused to identify similar and/or identical elements.

### DETAILED DESCRIPTION

A vehicle collision warning system may include sensors and other devices for detecting, for example, nearby objects. The vehicle collision warning system may then determine whether there is a potentially impending collision with one or more of the objects and when there is a potentially impending collision, generate a warning signal to a driver to take immediate action to avoid a collision. The vehicle collision warning system may interrupt and/or overlay a warning message on one or more displays, generate a signal via a haptic device, and/or perform another notification method to warn the driver of the potentially impending collision. If there is a high-probability of impact (or collision with an object) and the driver does not take quick action to respond to the notification, a collision may occur and thus is not avoided. This type of situation and notification refers to an urgent notification. Typically, there is only a single urgent notification that is provided by a host vehicle at any instance in time. A driver response to an urgent notification message may need to be provided in less than, for example, 1-3 seconds to avoid an impending result such as an impending collision.

As used herein a “non-urgent notification message” refers to a notification message for situations that do not need an immediate response. A driver response to a non-urgent notification message may be provided in, for example, 5 or more seconds after the notification message is generated to prevent an impending result such as a collision. A driver response to a non-urgent notification message may be provided, for example, 10-20 seconds, or even as much as 1-2 minutes after the notification message is generated to avoid the impending result that may occur should no response be provided within that period of time. As an example, during an assisted driving mode, such as a lane keeping and/or centering mode, a non-urgent notification message may be generated to request the driver to take over driving control, change lanes before exiting a highway, etc. Multiple non-urgent notification messages may be displayed. A non-urgent notification message may be provided as a displayed icon, image of an object, a symbol, and/or text. A non-urgent notification message may also or alternatively be provided as an audio signal, a haptic signal, and/or other visual, audio, and/or touch-based message.

A main difference between an urgent notification message and a non-urgent notification message is an amount of time available to prevent an impending outcome (e.g., an impending collision). The difference is not based on the consequence of not responding and/or the importance of the notification but rather is based on the “urgency” or amount of time available to respond before an event (e.g., a collision) occurs.

The examples disclosed herein are primarily directed to the providing of non-urgent notification messages. This includes the active generation, updating, ranking and displaying of notification messages. The examples include the ranking of the non-urgent notification messages and the adaptive updating and displaying of the notification messages based on the ranking. For example, the order, location, brightness, boldness, color, animation, blinking rate, and/or other characteristics may be adjusted to alert the driver and make the higher ranked non-urgent notification messages more salient than other lower ranked non-urgent notification messages. The higher ranked notification messages may blink, be brighter, be bolder, be louder, be larger, and/or have more noticeable coloring, etc. than the lower ranked notification messages.

The non-urgent notification messages may be displayed on one or more displays, such as on a center console display, a cluster or dashboard display behind a steering wheel, a head-up display (HUD), etc. The non-urgent notification messages may be provided via audible devices, video devices, haptic devices, etc. and/or a combination thereof. The non-urgent notification messages are provided such that driver responses to the notification messages are able to be detected and correlated respectively to the notification messages. The non-urgent notification messages are provided to improve situation awareness of a driver, to improve driver confidence, and to reduce and/or minimize anxiety levels of the driver.

The examples set forth herein include a system to adaptively arrange non-urgent (also referred to as non-emergent) notification messages to a driver given an abundant amount of information services intended for environmental situation awareness. The environmental situation awareness may refer to awareness of nearby traffic, traffic lights, nearby objects, street signs, exit ramps, entrance ramps, merging lanes, etc. The non-urgent notification messages are provided, based on a driver response to each previously provided non-urgent notification message based on driver preferences. Due to the nature of certain information service (especially services guiding a decision of a driver toward an intermediate distance), the system may i) associate the desired response from the driver with a relevant notification message, and ii) detect whether the driver has responded appropriately (e.g., showing attentions to the non-urgent notification messages and/or taking appropriate actions). The system may then better prioritize the provided notification messages to achieve improved assistance for the driver. This approach extends to other situations when a driver's response is detectable and the ride quality of occupants within a vehicle implementing an automated driving system is a concern.

The examples set forth herein improve driver awareness and allow a driver to benefit, subject to awareness constraints, from the non-emergent notification messages reflecting on-going traffic situations. The examples make use of the detectability of driver responses (e.g., the driver showing attentiveness and/or taking actions) in response to a certain one or more of the notification messages. The priority ranking of the available notifications is updated based on the detected responses from the driver.

The priority ranking of the available non-urgent notification messages may be presented on a human machine interface (HMI) using parallel or supplemental inputs of a “risk mitigation” metric and an “advantage gaining” metric for each notification message. These metrics rely on evaluation of driver responses, fulfillment status of the driver responses associated with the notification messages etc. A risk mitigation metric refers to a value that is indicative of distances between a host vehicle and other nearby vehicles (referred to as headway), presence of surrounding vehicles, etc. An advantage gaining metric refers to a value that is indicative of i) an amount of traveling time saved if the driver responds appropriately to the notification message, ii) an amount of energy consumption saved if the driver responds appropriately to the notification message, iii) an anxiety level of the driver if the driver responds appropriately to the notification message, etc. The advantage gaining metric refers to an expected advantage for persistent awareness (i.e., expected reduction of traveling time, energy consumption, anxiety level, etc. toward a certain reference location, if the driver gets persistently updated about the associated situation from the current time instant). The advantage gaining metric may be referred to as the reward. The priority ranking is also based on the driver responses.

For the non-urgent notification messages which are deemed as not prominently distinguished by their priority ranking metrics together with the involved driver responses, a learning-based ranking approach is utilized to determine the priority ranking of the notification messages. This may include a learning-based update on driver preferences based on the actual responses from a driver. The driver preference model is updated when performing the learning-based ranking approach. The learning-based ranking is implemented based on driver responses to update combined metric values respectively for the non-urgent notification messages. Example combined metric values are provided below. The non-urgent notification messages are ranked based on the combined metric values.

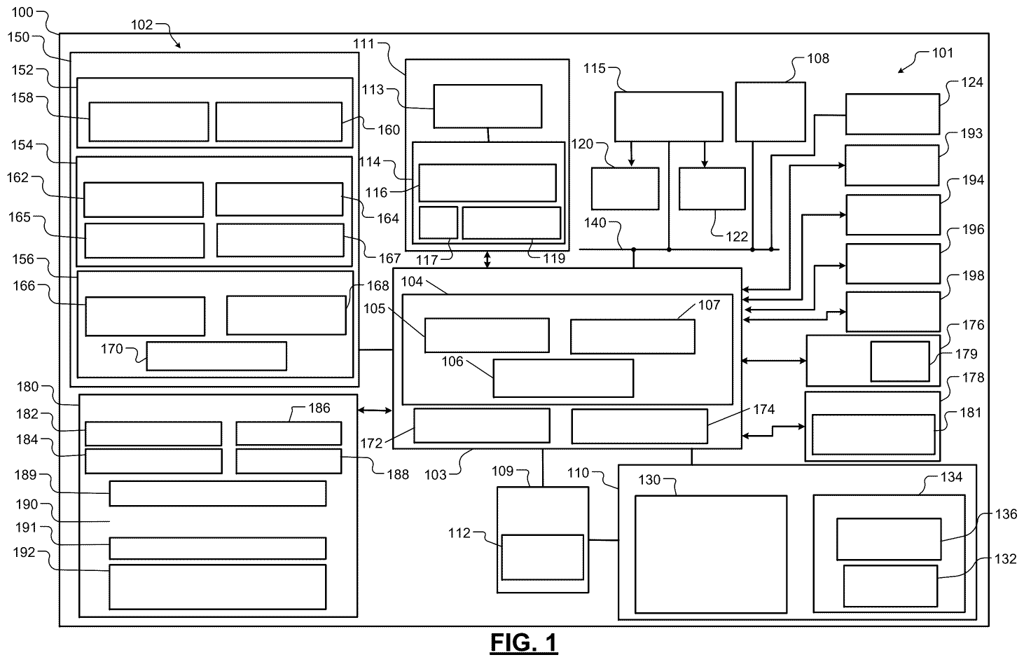

FIG. 1 is a functional block diagram of a host vehicle 100 including an example ADAS (or DAS) 101 with a DMS 102. The ADAS 101 includes a vehicle control module 103 having an assisted driving module 104, which includes an adaptive alert module 105. The adaptive alert module 105 generates, updates, modifies, and removes non-urgent notification messages.

The ADAS 101 may be configured to perceive the road ahead and surrounding environment based on outputs of sensors (e.g., cameras, radar sensors, and/or lidar sensors) and vehicle-to-everything (V2X) communication including vehicle-to-vehicle communication, vehicle-to-mobile device communication, vehicle-to-infrastructure communication, and other communication (e.g., vehicle to distributed network communication).

The assisted driving module 104 includes the adaptive alert module 105, a ranking module 106 and an active learning module 107. Although shown as separate modules, two or more of the modules 103, 104, 105, 106, 107 may be combined and implemented as a single module. The adaptive alert module 105 performs adaptive non-urgent notification alerting as described herein. The ranking module 106 ranks non-urgent notification messages as described herein. The active learning module 107 performs active learning to determine driver preferences as described herein.

The host vehicle 100 may be a non-autonomous, partially autonomous, or fully autonomous vehicle. The host vehicle 100 may operate in an autonomous mode to drive the host vehicle 100 to a destination. While operating in the autonomous mode, the host vehicle controls vehicle driving operations such as steering, accelerating, and braking operations. During the autonomous mode, a driver of the vehicle may override autonomous control and thus return driving control of the vehicle back to the driver.

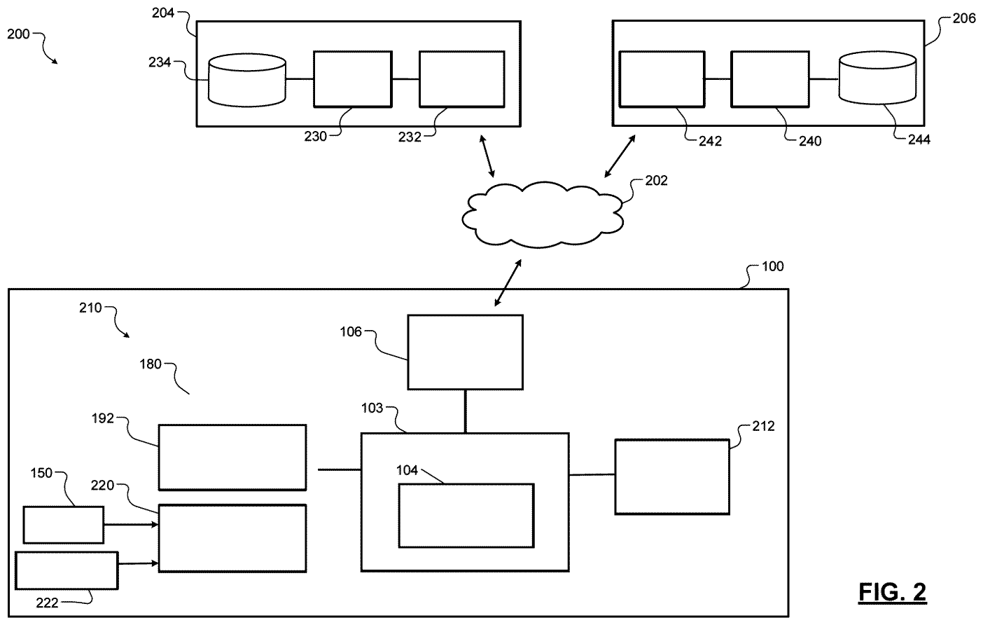

A portion of the DAS 101 is shown in FIG. 1 and additional details of the DAS are shown and/or described with respect to FIGS. 2-7. The assisted driving module 104 may perform: perception (or situation) determining operations; object detection, identification, classification, and graphical and visual identification operations; data look-up, collection, and gathering operations; interaction timing operations; assisted driving operations; image overlay operations; dialog operations including providing speech, text, and/or haptic messages; etc. The vehicle control module 103 may perform various operations based on the interaction with the driver and the messages, generated as further described below.

The host vehicle 100 further includes one or more power sources 109, a telematics module 111, an infotainment module 115, other control modules 108 and a propulsion system 110. The vehicle control module 103 may control operation of the vehicle 100 including the propulsion system 110. The power sources 109 may include one or more battery packs, a generator, a converter, a control circuit, terminals for high and low voltage loads, etc., as well as one or more battery sensors 112 for detecting states of the power sources 109 including voltages, current levels, states of charge, etc.

The telematics module 111 provides wireless communication services such as information services within the host vehicle 100 and wirelessly communicates with service providers, network devices, other vehicles, mobile devices, infrastructure devices, and other devices external and/or internal to the host vehicle 100. The telematics module 111 may support Wi-Fi®, Bluetooth®, Bluetooth Low Energy (BLE), Ultra Wideband (UWB), near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 111 may include one or more transceivers 113 and a navigation module 114 with a global positioning system (GPS) and GNSS (or Global Navigation Satellite System) receiver 116. The navigation module 114 may include an inertial measurement unit (IMU) 117 and an odometer/wheel sensor 119. The transceivers 113 wirelessly communicate with network devices internal and external to the host vehicle 100 including cloud-based network devices, central stations, back offices, and portable network devices. The transceivers 113 may perform pattern recognition, channel addressing, channel access control, and filtering operations.

The navigation module 114 executes a navigation application to provide navigation services. The navigation services may include location identification services to identify where the host vehicle 100 is located. The navigation services may also include guiding a driver and/or directing the host vehicle 100 to a selected location. The navigation module 114 may communicate with a central station to collect map information indicating levels of traffic, transportation object identification and locations (e.g., locations and types of signs), path information, where rest areas are located, where gas stations are located, where restaurants are located, etc. As an example, if the host vehicle 100 is an assisted and/or automated driving vehicle, the navigation module 114 may direct the vehicle control module 103 along a selected route to a selected destination. The GPS and GNSS receiver 116 may provide vehicle velocity and/or direction (or heading) of the host vehicle 100 and other vehicles and objects (e.g., pedestrians and cyclists) and/or global clock timing information.

The infotainment module 115 may include and/or be connected to an audio system 122 and/or a video system including one or more displays (one display 120 is shown). The displays 120 and audio system 122 may be part of a human machine interface. The displays 120 may include cluster and/or center console displays, head-up displays, etc. Haptic devices 124 (e.g., steering wheel and/or seat vibration devices) may be used in addition to the displays and the audio system 122 to interact with a vehicle occupant such as a driver. This interaction is further described below. Messages (e.g., urgent and non-urgent notification messages) may be displayed, audibly played out, and/or indicated via the displays 120, the audio system 122, the haptic devices 124, and/or via one or more other output devices.

The infotainment module 115 may provide various informative, warning, and proactive messages including information regarding: upcoming and currently being performed operations (e.g., braking, accelerating, turning operations), detected objects (or obstacles); upcoming and/or nearby gas stations, upcoming and/or nearby restaurants, music services, upcoming and/or nearby shops, vehicle status information, diagnostic information, prognostic information, entertainment features, etc. The infotainment module 115 may be used to guide a vehicle operator to a certain location, indicate trip estimations (e.g., distances to selected destinations), and other information.

The propulsion system 110 may include one or more torque sources, such as one or more motors and/or one or more engines (e.g., internal combustion engines). In the example shown in FIG. 1, the host vehicle 100 includes an engine 130 and one or more motors 132. The torque sources are independently controlled. The propulsion system 110 includes a motor control system 134 that includes the one or more motors 132 and a motor control module 136 that may control operation of the one or more motors 132 based on signals from the vehicle control module 103.

The modules 103-108, 111, and 115 may communicate with each other directly or via one or more buses 140, such as a controller area network (CAN) bus and/or other suitable interface. The vehicle control module 103 may control operation of vehicle modules, devices and systems based on feedback from sensors 150.

The sensors 150 may include exterior sensors 152, interior sensors 154, and other sensors 156. The exterior sensors 152 may include radar and/or lidar sensors 158 and imaging and audio devices (e.g., visual spectrum cameras, long-wave infrared cameras, short-wave infrared cameras, ambient light sensors, and microphone or microphone array) 160. The exterior sensors 152 may be used to detect objects external to the host vehicle 100 and/or in a path of the host vehicle 100.

The interior sensors 154 may include interior imaging sensors (e.g., cameras) 162, a microphone or microphone array 164, one or more imaging radar sensors 165, and one or more laser scanning sensors 167. The interior sensors 154 may be part of the DMS 102. The interior sensors 154 may be used to monitor a vehicle occupant to detect and track head locations and/or eyes locations a gaze directions. Locations and movements of vehicle occupant head and eyes may be tracked. As an example, the interior sensors 154 may track posture, arm and hand locations, and eyes of a driver. This includes determining eye locations and eye gaze direction, detecting gestures made by the driver, detecting orientation of a body of the driver, detecting speech of the driver, etc. This monitoring may be used to determine in which directions the driver is looking, what object(s) the driver is looking at, etc.

The other sensors 156 may include a vehicle speed sensor 166, acceleration sensors (e.g., longitudinal and lateral acceleration sensors) 168, and a fuel level sensor 170, as shown, and other sensors such as an inclinometer, an engine temperature sensor and an engine oil pressure sensor. Additional sensors may also be included such as brake system sensors (a brake sensor 179 is shown) and steering system sensors (a steering angle sensor 181 is shown).

The assisted driving module 104 may use machine learning for object classification including to identify and/or classify pedestrians, cyclists, and vehicles (e.g., oncoming traffic), as well as for probable trajectory determination of each detected, identified and/or classified object. The assisted driving module 104 may determine the locations of objects based on feedback from the sensors 150. The assisted driving module 104 may also detect driver (or occupant) head and eye position and gaze angle, which may be used to determine whether the occupant is looking at one or more non-urgent notification messages and for how long the occupant is looking at the one or more non-urgent notification messages.

The vehicle control module 103 may also include a mode selection module 172 and a parameter adjustment module 174. The mode selection module 172 may select a vehicle operating mode. The parameter adjustment module 174 may be used to adjust parameters of the host vehicle 100. The vehicle control module 103 may perform autonomous operations based on interaction with a vehicle occupant. As an example, the vehicle control module 103 may operate in a fully or partially autonomous mode and may control the propulsion system 110, a brake system 176, and a steering system 178. In an embodiment, the vehicle control module 103 controls operation of the systems 110, 176 and 178 based on interactions with a vehicle occupant. The vehicle control module 103 may i) perform autonomous operations such as steering, braking, accelerating, etc., and/or ii) display and/or audibly playout messages, perform haptic operations via haptic devices 124, and/or output messages and/or corresponding signals via other output devices.

In an embodiment, the DAS 101 uses computer vision, machine learning and cloud computing to identify, communicate, and evaluate scenarios where a moving host vehicle should yield to pedestrian(s), an obstructed roadway, and/or oncoming (right-of-way) traffic. The DAS 101 visualizes and takes into consideration in real-time pedestrians, roadway obstructions and oncoming traffic and performs operations to provide enhanced situation awareness to vehicle occupants. The DAS 101 provides situation awareness in automated driving modes to increase user trust and aid in vehicle take-over.

In an embodiment, a vehicle occupant (e.g., driver or passenger) may manually override operations performed by the DAS 101. This may include, for example, steering, braking and/or accelerating operations being performed. This may be done by, for example, gently tapping on the brake or the accelerator to partially or fully disengage the DAS 101. The DAS 101 is configured to perceive the road ahead and surrounding areas based on outputs of sensors (e.g., cameras, radar sensors, and/or lidar sensors) and vehicle-to-everything (V2X) communication including vehicle-to-vehicle communication, vehicle-to-mobile device communication, vehicle-to-infrastructure communication, and other communication (e.g., vehicle to distributed network communication).

The host vehicle 100 may further include the memory 180. The memory 180 may store sensor data 182, parameters 184, applications 186, algorithms 188, historical data 189, a driver preferences model 190, off-board inputs 191 from other devices external to the host vehicle 100 and other data 192. The parameters may include sensor parameters such as vehicle speed, vehicle acceleration, battery state of charge, fuel level, etc. The applications 186 may include applications executed by the modules 103-108, 111, and 115.

Although the memory 180 and the vehicle control module 103 are shown as separate devices, the memory 180 and the vehicle control module 103 may be implemented as a single device. The memory 180 may also store historical data 189 and other data 192 such as driver driving patterns, driver fueling patterns, driver stopping patterns, driver pickup patterns, other driver patterns, data collected by and/or generated by at least one of the modules 103-108, 111, and 115, traffic data, navigation data, map data, GPS data, path data, speed data, and acceleration data, etc.

The vehicle control module 103 may control operation of the propulsion system 110, the video system including the display 120, the audio system 122, the haptic devices 124, the brake system 176, the steering system 178, a heating ventilation and air-conditioning (HVAC) system 193, a lighting system 194, a seating system 196, a mirror system 198, and/or other devices and systems according to parameters set by the modules 103-108, 111, 115, and 174. The vehicle control module 103 may set at least some of the parameters based on signals received from the sensors 150. The lighting system 194 may include various interior lights, series of light emitting diodes (LEDs), light bars, etc. The lighting system 194 may also include and/or control the amount of ambient light entering the vehicle by adjusting tint levels of windows, opening and/or closing one or more shades, etc.

The vehicle control module 103 may receive power from the power sources 109, which may be provided to the propulsion system 110, the brake system 176, the steering system 178, a HVAC system 193, the lighting system 194, the seating system 196, the mirror system 198, etc. Power supplied to the haptic devices 124, the motors 132, the brake system 176, the steering system 178, a HVAC system 193, the lighting system 194, the seating system 196, the mirror system 198, and/or actuators thereof may be controlled by the vehicle control module 103 to, for example, adjust: motor speed, torque, and/or acceleration; braking pressure; steering wheel angle; pedal position; state of haptic devices 124; etc. This control may be based on the outputs of the sensors 150, the navigation module 114, the GPS and GNSS receiver 116, the data and information received from external devices, and the data and information stored in the memory 180.

The vehicle control module 103 may determine various parameters including a vehicle speed, a motor speed, a gear state, an accelerator position, a brake pedal position, an amount of regenerative (charge) power, an amount of auto start/stop discharge power, and/or other information. The vehicle control module 103 may control operations of the systems 110, 176, 178 based on the stated parameters. The assisted driving module 102 may display vehicle status information based on the stated parameters.

The assisted driving module 104 monitors real-time behavior of vehicle occupants including speech, gaze patterns, head positions, gestures (e.g., hand gestures, finger gestures, facial gestures, etc.). Gaze patterns include directions of an occupant's head and eyes. This information is used to determine where, how, duration, timing, and intensity of alerts and other conversational messages.

The host vehicle 100 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering and accelerating operations to drive the vehicle to the destination based on the map information.

As another example, the host vehicle 100 may include object detection and collision warning systems for detecting impending objects and performing countermeasures and/or taking evasive action to prevent a collision. The vehicle control module 103 determines locations of the objects relative to the host vehicle 100 and trajectories of the objects and the host vehicle 100. If it is determined that the host vehicle 100 is likely to collide with one of the objects, one or more warning signals may be generated to indicate to the driver and/or the object of concern of the potential collision. These warnings may be provided in addition to other information described herein. The vehicle control module 103 may also or alternatively perform one or more other countermeasures (e.g., apply brakes to decelerate the host vehicle, change a steering angle of the host vehicle, etc.) to prevent a collision.

FIG. 2 shows a communication system 200 including the host vehicle 100, a distributed communications system 202, a cloud-based network device 204, and a back office 206. A portion 210 of the DAS 101 of FIG. 1 is shown. The portion 210 includes the vehicle control module 103, the telematics module 111, the memory 180, and an HMI 212, which may include any interfacing devices referred to herein including displays, speakers, haptic devices, lights, etc. The assisted driving module 104 may utilize a windshield as a display and provides an augmented reality via an augmented reality heads up display (ARHUD). The vehicle control module 103 includes the assisted driving module 104.

The memory 180 includes the off-board inputs 191 and on-board inputs 220. The off-board inputs 191 may include: GPS information; information received via the Internet; and/or information received via V2X communication, WiFi communication, cellular communication, and/or satellite communication. The off-board inputs 191 may include information received from the cloud-based network device 204 and/or the back office 206. The on-board inputs 220 may include responses to non-urgent notification messages, posture, arm, hand and head positions, eye positions, and gaze angle of a vehicle occupant, automated driving system status information, vehicle braking information, steering angle information, object detection information, vehicle acceleration information, etc. The on-board inputs 220 may be provided by the sensors 150 and input devices 222. The input devices may include one or more displays, push buttons, a microphone, and/or other input devices. At least some of the information may be provided via the sensors referred to herein.

The cloud-based network device 204 may include a control module 230, a transceiver 232, and a database 234. One or more cloud-based network devices may be included and include one or more edge devices. The back office 206 may include a control module 240, a transceiver 242, and a database 244.

The devices 204, 206 may create, store, and modify occupant preference profiles, each of which being specific to a particular person (driver and/or vehicle occupant). A profile may include preferences with regards to notification messages, when and what type of alert message to provide, locations and types of notification messages, how notification messages are provided, whether the person likes reactive messages, whether the person likes proactive messages, etc. As an example, a profile may indicate if a person has loss of hearing, limited feeling in legs or rear, etc. such that certain types of notification messages should not be provided. A profile may indicate if a driver typically looks at a particular display and to provide notification messages on that display. A profile may be accessed for a driver based on the driver's dedicated identifier (ID), using face recognition, fingerprint recognition, voice recognition, a username, a password, etc. The profiles are shared with the vehicle and may be created, stored and/or modified by the vehicle, such as by the assisted driving module 104 and/or one of the modules 103 and 105-108 of FIG. 1. The preferences may be used and updated during each drive cycle and/or each notification messaging event. The preferences may also be shared with multiple vehicles. A driver may switch vehicles and the driver's preferences may be provided to and used by each of the vehicles.

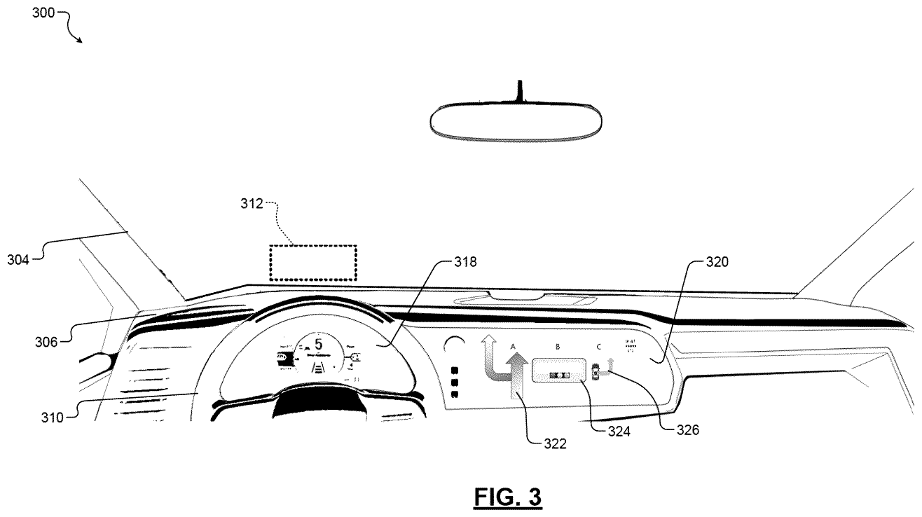

Machine learning algorithms may be used to classify types and trajectories of objects located within range of the planned pathway of host vehicle 100. The assisted driving module 104 may provide a graphical user-interface to convey presence and intention (i.e., predicted paths) of detected objects. The assisted driving module 104 may track locations of the host vehicle 100 and other objects, speed of host vehicle 100 and other objects, trajectories of the host vehicle 100 and other objects, roadway curvatures, vehicle steering, etc. and output and/or display notification messages via the HMI 212 based on these locations, speeds, trajectories, and roadway curvatures. The assisted driving module 104 may also display the images having selected type, brightness, size, shape, animation, blink rate, color, etc. based on the stated information and occupant position, host vehicle location, and other vehicle sensed aspects of the driving environment. The images may be displayed as non-urgent notification messages. Some example images are shown in FIG. 3.

FIG. 3 shows an interior 300 of a vehicle providing adaptive alerting of non-urgent messages, which have been ranked and are displayed from left to right in order of ranking (e.g., highest to lowest). A windshield 304 is visually located above a dashboard 306 of the vehicle 300. The vehicle 300 may include a steering wheel 310. The vehicle 300 may be an autonomous vehicle, a semi-autonomous vehicle, or a non-autonomous vehicle. A HUD projection (or image) 312 of a holographic projection system (or HUD) is shown, which is projected onto a portion of the windshield 304. The projection may be provided through an aperture in the dashboard 306. The image 312 may include various vehicle information, such as a present speed of the vehicle, a present gear of a transmission of the vehicle, an engine speed, a directional heading of the vehicle, present infotainment system settings, and/or other vehicle information. An urgent and/or non-urgent notification message may be displayed as part of the image 312. In an embodiment, a highest ranked one of the non-urgent notification messages is displayed as part of the image 312 and other non-urgent notification messages are displayed and/or provided via other devices, such as other displays, haptic devices, audio devices, etc. The image 312 presents data to the driver of the vehicle without the driver having to look away from objects in front of the vehicle. A cluster display 318 and a center console display 320 are shown.

The center console display 320 is shown and may display, for example, non-urgent notification messages such as non-urgent notification messages 322, 324, 326. In the example shown, the notification message 322 (or A) is higher ranked than notification message 324 (or B), which is higher ranked than notification message 326 (or C). The non-urgent notification messages 322, 324, 326 may be ranked using three criteria, namely, i) responses of a driver to the non-urgent notification messages 322, 324, 326, ii) evaluations of non-urgent notification messages 322, 324, 326 by risk and reward, and iii) when there is lack of distinction between the non-urgent notification messages 322, 324, 326, utilizing a learning based ranking approach is implemented for driver preferences. The responses of the driver may include: showing attention to a notification message (e.g., visual looking toward a notification message); taking vehicle action to a notification message; and touching buttons/controls in vehicle to acknowledge/dismiss notifications.

As an example, the three non-urgent notification messages 322, 324, 326 may be displayed concurrently, where the notification message 322 refers to insight about lane change and speed variation trends to some intermediate distance ahead of host vehicle. The notification message 324 refers to a suggested non-emergency speed adjustment. The notification message 326 refers to nearby vehicle action (e.g., a vehicle is cutting into lane of host vehicle. A priority ranking may be provided based on the following assumptions: i) the driver has just detected to show response to B, making B have a decreased risk mitigation metric; ii) the risk mitigation metric of C is even lower because the response to B supersedes the response to C because responding to B resolves C; iii) B and C have low advantage gaining metrics; and iv) A has a higher advantage gaining metric because the driver has not yet shown desired response to A, which is helpful to gain advantage in traveling time. Thus, a notification message for which there has been a lack of (or no) response by a driver may have a higher ranking than a notification message for which there has been a response by the driver. A response may be simply the driver noticing and/or looking at the notification message and ignoring the notification message. Alternatively, a response may include the driver noticing and/or looking at the notification message and performing an action in response to looking at the notification message. A lack of response may refer to the driver not noticing and/or looking at a notification message. Considering a combination of the risk mitigation metric and advantage gaining metric for each of A, B and C, the priority ranking is determined to be A>B>C.

Non-urgent notification messages may be continuously and actively re-ranked and ordered. The non-urgent notification messages may also be continuously updated (or modified) by making higher priority notification messages more salient in terms of visualization style (e.g., location, color, animation, etc.) and/or noticeability. This is done to serve a driver's optimal benefit of environmental situation awareness (e.g., traffic situation awareness).

FIG. 3 shows the non-urgent notification messages 322, 324, 326 are presented in a selected order and having respective sizes. This is based on the ranking of these messages such that message 322 has a highest saliency level and message 326 has a lowest saliency level. A is larger than B which is larger than C. In an embodiment, one or more of the messages 322, 324, 326 are displayed as part of image 312 of the HUD. In this example, message 322 is a symbol representing an upcoming lane change and speed variation trend of traffic to some intermediate distance ahead. Message 324 is a symbol representing a non-emergency speed adjustment. Message 326 is a symbol representing a nearby vehicle action. These messages 322, 324, 326 are each determined based on evaluations of a respective pair of risk mitigation and advantage gaining metrics.

In this example and describing the situation intuitively, the driver is already detected to show response to B and this makes B have a reduced risk mitigation metric. This metric of C is lower than B because the response to B supersedes the response to C. Both B and C have low advantage gaining metrics, while A has a high advantage gaining metric because the driver has not yet shown a desired response to A, which is helpful to gain an advantage at an intermediate distance. Then considering a combination of the risk mitigation and advantage gaining metrics, the priority ranking is determined to be A>B>C. The population and priority ranking of the notifications are both dependent on the real-time parsing of the received information service messages, together with the detection of the driver's responses associated with the notifications.

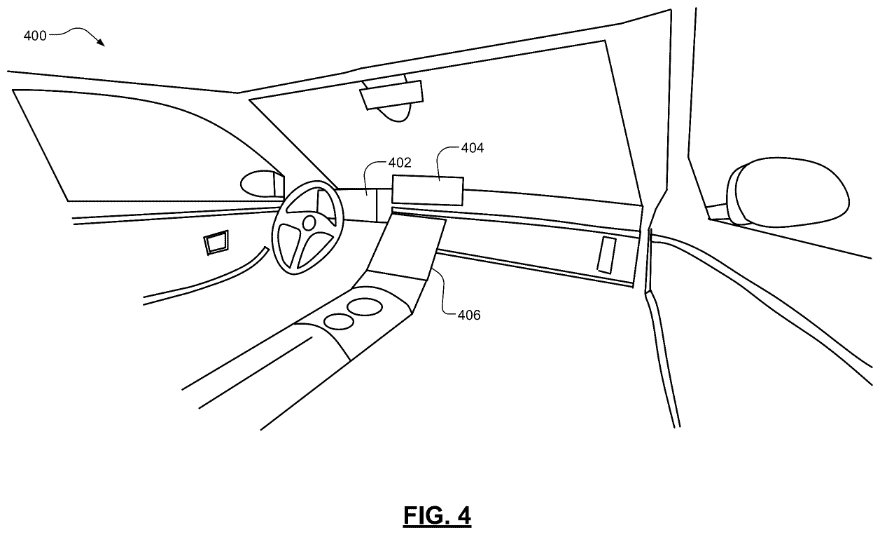

FIG. 4 shows an interior 400 of a vehicle providing adaptive alerting of non-urgent messages. The interior 400 includes a cluster display 402 and two center console displays 404, 406. Each of these displays 402, 404, 406 may be used to display the non-urgent notification messages.

In an embodiment, one of the displays of a host vehicle is referred to as a primary display and another display is referred to as a secondary display. The highest ranked non-urgent notification message may be displayed on the primary display and other non-urgent notification messages may be displayed on the secondary display. The primary display may be, for example, the head-up display 312 of FIG. 3 or the cluster display 402 of FIG. 4. The secondary displays may refer to one of the displays 318, 320 of FIG. 3 and 404, 406 of FIG. 4.

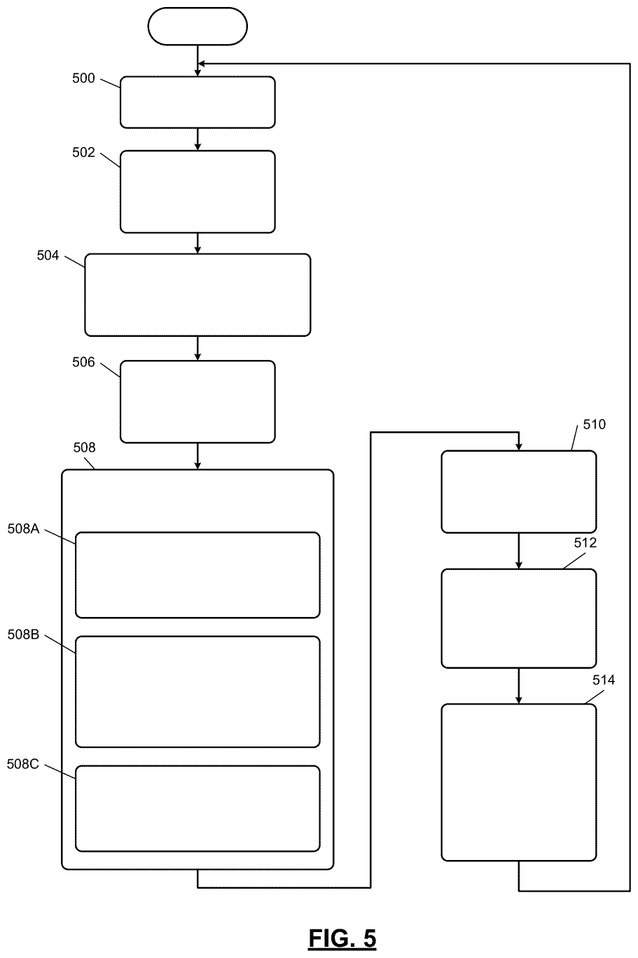

FIG. 5 shows a method of interactive with a vehicle driver including providing a detecting response to non-urgent notification messages. The driver's response to system notifications can be in the form of: i) explicit action (e.g., changing lane, intentionally reducing or increasing speed) as determined by vehicle motion control sensors; ii) the closeness of line-of-sight (i.e., gazing direction) to the display location of the notification message within certain time duration, as determined by the DMS; and iii) manual dismissal of certain notification messages through physical buttons and/or touch control. The following operations may be iteratively performed.

At 500, the adaptive alert module 105 may receive outputs from sensors, such as the sensors referred to herein.

At 502, the adaptive alert module 105 may receive environmental information including object information, road information, etc., for example, from the telematics module 111.

At 504, the adaptive alert module 105 may determine non-urgent notification messages to generate based on the sensor outputs and environmental information.

At 506, the adaptive alert module 105 may generate and/or update non-urgent notification messages for driver of the host vehicle.

At 508, the adaptive alert module 105 may detect driver responses to one or more of the generated non-urgent notification messages.

At 508A, the adaptive alert module 105 may detect driver responses via vehicle motion control sensors confirming driver's action in response to one of the non-urgent notification messages.

At 508B, the adaptive alert module 105 may detect a driver response via the driver monitoring system including i) detecting line-of-sight and attention time that the driver spent on the one of the non-urgent notification messages, and/or ii) receiving an input from the driver (e.g., a gesture command).

At 508C, the adaptive alert module 105 may detect a driver response via an input device such as an explicit dismissal of or other input for one of the non-urgent notification messages. The driver response may be provided via, for example, push buttons and/or touch control via other input devices.

At 510, the adaptive alert module 105 may associate the driver responses with corresponding ones of the non-urgent notification messages.

At 512, the adaptive alert module 105 may adjust affected metrics for the associated notification messages based on the driver responses. The metrics include the risk mitigation metrics and advantage gaining metrics of the non-urgent notification messages.

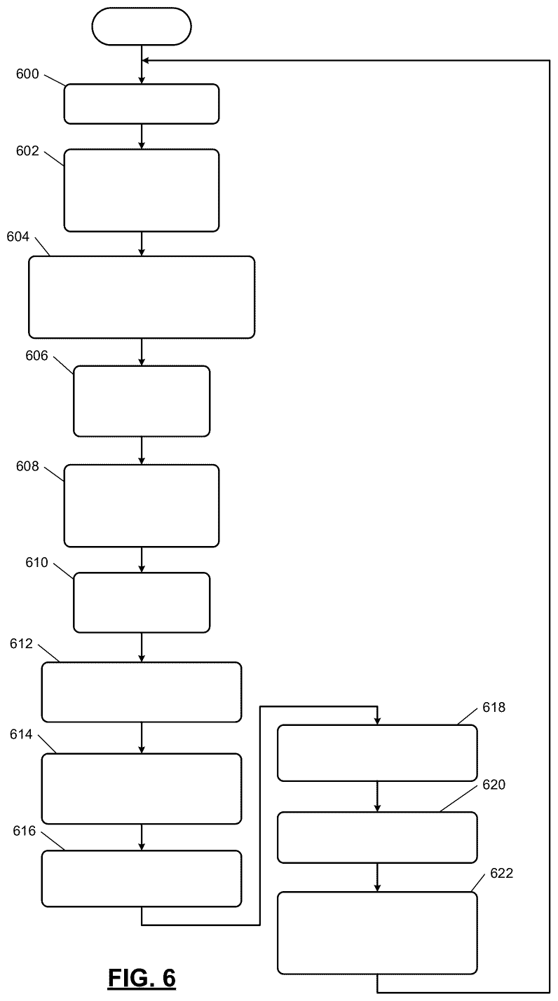

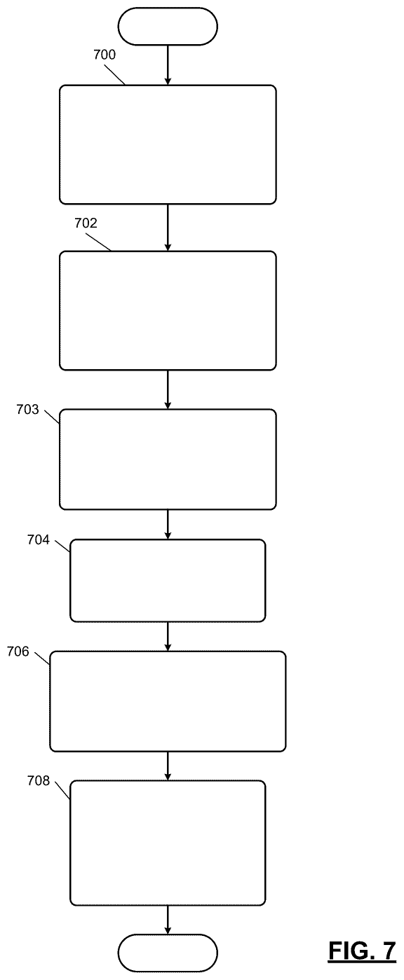

At 514, the adaptive alert module 105 updates the notification messaging based on the updated priority ranking of the non-urgent notification messages and optionally provides an explanation for the updates. The explanations may be provided via, for example, a display. The new priority ranking may be provided after operation 512 and before operation 514 as described below with respect to operation 612 of FIG. 6 and the method of FIG. 7.

FIG. 6 shows a method of generating, updating, removing, parsing, and ranking non-urgent notification messages and providing ranked non-urgent notification messages to a driver. The method of FIG. 6 includes an iterative processing loop for dynamically prioritizing available non-urgent notification messages. The method i) accounts for inputs of received information service messages (or telematics data/messages) and detected driver responses, ii) involves determining driver's preferences on notification prioritization as part of a learning-based method, and iii) accumulates relevant data for incremental learning for an improved driver preference model. The driver preference model is used during the priority ranking operation 612, following the evaluations of risk mitigation metrics and advantage gaining metrics of the available non-urgent notification messages. The use of the driver preference model is meant to rank notifications which are not prominently distinguished by their ranking metrics, such that the driver can optimally benefit from the notifications. The operations are preformed to make the drier optimally benefit from (subject to awareness constraints) the non-emergent notification messages given V2V and cloud-based information services. The following operations may be iteratively performed.

At 600, the adaptive alert module 105 may receive outputs from sensors, such as the sensors referred to herein.

At 602, the adaptive alert module 105 may receive environmental information including object information, road information, etc., for example, from the telematics module 111.

At 604, the adaptive alert module 105 may determine non-urgent notification message to generate based on the sensor outputs and environmental information.

At 606, the adaptive alert module 105 may generate non-urgent notification messages.

At 608, the adaptive alert module 105 may parse updated non-urgent notification messages for driver of host vehicle. The adaptive alert module 105 may parse pooled information service messages into notification messages that are ready to be pooled and displayed to a driver, following the reception of new messages of this type during operation 616.

At 610, the adaptive alert module 105 may remove out-of-impact notification messages (if any) from, for example, the memory 180 of FIG. 1. The adaptive alert module 105 determines if any of the currently pooled notification messages are out of impact (i.e., determines if any notification messages have no information value to the driver for risk mitigation and/or advantage gaining) based on both the pooled driver responses and the relevant changes of traffic situation. Operation 610 may be performed in parallel with operation 608 and does not need to be synchronized with operation 608.

At 612, the ranking module 106 determines an updated priority ranking of the non-urgent notification messages. The method of FIG. 7 may be performed when operation 612 is performed to determine the updated priority ranking. The driver preference model is utilized as part of a learning-based approach to determine the priority ranking among the notification messages not prominently distinguished by their priority ranking metrics together with the relevant driver responses. The method of FIG. 7 may be performed with the information provided by operations 608, 610, 620, and 622.

The method of FIG. 7 may also utilize past priority rankings for certain past durations, subject to certain timer and/or trigger event, and determine the new priority ranking of the pooled notification messages. The phrase “subject to certain timer and/or trigger events” means that the next iterations of the processing loop are carried out at certain pre-determined and evenly spaced time instants or carried out upon a certain event having occurred. In the case of a timer, the iterations are typically carried out with some periodicity. In the case of a trigger event, the ranking module 106 waits for an event occurrence that relates to the representable notification messages, e.g., a newly parsed notification message, newly detected driver response, and/or rule-based expiration of an existing notification message.

At 614, the adaptive alert module 105 may update the output and/or display of notification messages. In an embodiment, the adaptive alert module 105 updates the display of notification messages based on the priority ranking determined by operation 612 such that the primary display area accommodates a limited number (e.g., 3) of the highest-ranked notifications, while the remaining ones are accommodated on the secondary display area. The display of notifications may also incorporate the visualization styles such as the gradual transition of colors and locations to make them more explainable and intuitively understandable to the driver, according to the driver preference model and/or the relevant configurable options. In an embodiment, operation 618 is performed after operation 614.

At 616, the adaptive alert module 105 updates and/or preprocesses the stored notification messages. For the newly received information service messages not yet processed in the current iteration, the adaptive alert module 105 performs some pre-processing for them to be processed in the next iteration. In an embodiment operation 600 is performed after operation 616.

At 618, the adaptive alert module 105 may receive, detect and/or monitor driver responses to the non-urgent notification messages outputted to the driver. The non-urgent notification messages may have been outputted via one or more displays, an audio system, an infotainment system, and/or one or more other output devices.

At 620, the adaptive alert module 105 may update the stored driver responses and corresponding non-urgent notification messages. For the newly detected driver responses not yet processed in the current iteration, the adaptive alert module 105 performs some pre-processing to determine what subsets of them are to be used as the inputs for operations 610, 612 in the next iteration of this method. In an embodiment, operation 600 is performed after operation 620.

At 622, the active learning module 107 may accumulate data for incremental learning and updating of the driver preference model. The active learning module 107 accumulates relevant data for incremental learning on the driver preference model such that the model is better able to serve the driver for traffic situation awareness in the future. The relevant data includes some collection of presented notification messages, together with both system-expected and actual outcomes including driver responses, response latencies, response durations, resulted improvements of spatial/temporal safety headroom, resulted improvements of time/energy consumptions etc. The learning approach may be established through reinforcement learning, and the reward metric being associated with the closeness between the system-expected and actual outcomes.

In addition to explicit action (e.g., changing lane, intentionally reducing or increasing speed) in response to a certain notification message and manual dismissal of another certain notification message, the driver responses to the notification messages also include the closeness of line-of-sight to the displayed location (i.e., detected gazing at the displayed location) of the notification message within a certain time duration, as determined by the DMS. An example diagram for the driver interaction perspective is provided by the method of FIG. 5. FIG. 5 shows how the driver interaction is involved in the process of priority ranking among the system-to-driver non-urgent notification messages, where the system monitors the driver response in the aspects of maneuvering action, visual attention and in-vehicle input, and associates the responses with the corresponding non-urgent notification messages.

FIG. 7 shows a method of ranking non-urgent notification messages. FIG. 7 may be performed to determine a new priority ranking of non-urgent notification messages, which may be “pooled” (i.e., collected and stored as available messages in a dedicated location of memory). An iterative processing loop is implemented to make the driver optimally benefit from (subject to awareness constraints) the non-emergent notification messages reflecting the on-going traffic situations. The iterative processing loop takes inputs of received information service messages, detected driver actions and/or attentions, and driver preferences provided in response to the prioritized notification messages regarding an on-going traffic situation and presents the notification message to a driver via the HMI. The iterative processing loop essentially treats the involved information service messages, notification messages, and driver responses as cached in respective “pools” (i.e., respective memory locations), and during each iteration parses the pooled notification messages into newly pooled notification messages. The iterative processing loop then applies the pooled driver responses on the whole notification pool to determine how the notification messages should be rearranged for display on the HMI. The following operations may be iteratively performed.

The following operations 700, 702 may be concurrently performed in parallel. At 700, the ranking module 106 may calculate the headroom (in terms of remaining time and/or distance) to perceivable impact for each corresponding non-urgent notification message. For each pooled notification, the ranking module 106 calculates the headroom in terms of remaining time and/or distance toward the associated impact being perceivable (i.e., the special/temporal point at which it is deemed too late to take action). This is based on the relevant data elements in the associated V2X messages together with the host vehicle status, as the risk mitigation metric of the notification message.

At 702, the ranking module 106 may calculate the expected advantage (in terms of time and/or energy savings, anxiety reduction, etc.) for the driver to keep awareness of each notification message. For each pooled notification message, the ranking module 106 calculates its expected advantage for persistent awareness (i.e., the expected reduction of travelling time, energy consumption, anxiety level etc. toward certain reference location, if the driver gets persistently updated about the associated situation from the current time instant), as the advantage gaining metric of the notification message.

At 703, the ranking module 106 may generate combined metrics based on the risk mitigation and advantage gaining metrics. The combined priority ranking metric for each notification message may be determined as a mean value (with fixed or adaptive weighting factors) of the risk mitigation and advantage gaining metrics. The risk mitigation and advantage gaining metrics of a notification message may be denoted as values (with appropriate units) such as Xᵣ and Xₐ, respectively. An example definition of the combined metric may be given by X_{c}=wXᵣ+(1−w)Xₐ, with w∈(0,1) denoting the weighting factor of Xᵣ. For a situation in which one of the risk mitigation and advantage gaining metrics is substantially larger or substantially smaller than the other one, the combined metric may be better behaved by defining

$${X}_{c}^{- 1} = {wX}_{r}^{- 1} + ( 1 - w ) {X}_{a}^{- 1} ,$$

i.e., defining X_{c}=XᵣXₐ/(wXₐ+(1−w)Xᵣ) as the weighted harmonic mean of Xᵣ and Xₐ.

At 704, the ranking module 106 may evaluate combined priority ranking metrics respectively for the notification messages. The ranking module 106 evaluates the combined priority ranking metric for each notification message based on its risk mitigation metric and advantage gaining metric, with a rule that favors the notification messages valuable for risk mitigation, while also favoring the notification messages of high advantage gaining metric among the ones less valuable for risk mitigation.

At 706, the ranking module 106 may pick out the notification messages (if any) with prominently high and prominently low metrics as the highest and lowest ranked notification messages. If any of the pooled notifications has prominently higher or prominently lower combined priority ranking metric than the remaining ones, the ranking module 106 picks out such notification messages as the highest and lowest ranked ones. In an embodiment, at most 2 notification messages are picked (a highest ranked one and a lowest ranked one).

At 708, the ranking module 106 may apply the learning-based ranking approach (i.e., the driver preference model) to determine the priority ranking among the remaining notification messages (if any). For the remaining pooled notification messages, the ranking module 106 applies the learning-based ranking approach (i.e., the driver preference model) to determine the priority ranking among them, if there are at least 2 or more as inferred based on driver preference of them.

The examples described herein make use of the detectability of driver responses toward certain non-urgent notification messages to dynamically determine the priority ranking among the notification messages. This is done to optimally benefit the driver. Risk mitigation metrics and advantage gaining metrics are evaluated in parallel and to supplement driver response inputs for priority ranking purposes of the notification messages. The learning-based ranking approach which models the driver preference, is used to rank the notifications not prominently distinguished based on the inputs of driver responses together with their “risk mitigation” and “advantage gaining” metrics. This is done such that the resulted priority ranking for the available notification message are better understandable and agreeable to the driver. To support the objective of improving the driver's awareness about the non-emergent traffic situation based on the priority ranking among the displayed notification messages, the examples include performing a priority ranking on the available notification messages iteratively to arrange them accordingly. The notification messages may be arranged into the referred to display area(s), based on the driver response inputs to the corresponding notification messages. This includes the detected driver responses such as the “attentions” and “actions” taken by the driver.

The examples described herein include priority ranking among the notification messages for improving the driver's awareness about the traffic situation. This is based on the consideration of the detectability of driver's response toward the notification messages, especially the ones guiding the driver's decision toward an intermediate distance. The examples include delimitation of the systematic context for priority ranking among the system-to-driver notification messages. The examples further include arrangement for different categories of inputs to the priority ranking functionality to optimally fit the systematic context.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An assisted driving system comprising:
a plurality of inputs configured to receive sensor data, telematics data, and driver response data;
an assisted driving module configured to, based on the sensor data and telematics data generate a first plurality of non-urgent notification messages; and
a ranking module configured to rank the first plurality of non-urgent notification messages based on the driver response data,
wherein the assisted driving module is configured, based on the ranking of the first plurality of non-urgent notification messages, to output via at least one output device the first plurality of non-urgent notification messages such that saliency of each of the first plurality of non-urgent notification messages is based on the respective ranking of that non-urgent notification message.

2. The assisted driving system of claim 1, wherein the assisted driving module is configured to output a highest ranked one of the first plurality of non-urgent notification messages with a highest saliency and to output a lowest ranked one of the first plurality of non-urgent notification messages with a lowest saliency.

3. The assisted driving system of claim 1, wherein the ranking module is configured to:
generate a respective risk mitigation metric and a respective advantage gaining metric for each of the first plurality of non-urgent notification messages; and
rank the first plurality of non-urgent notification messages based on the risk mitigation metrics and the advantage gaining metrics.

4. The assisted driving system of claim 3, wherein the ranking module is configured to:
generate a combined metric for each of the first plurality of non-urgent notification messages based on the respective risk mitigation metric and respective advantage gaining metric for that non-urgent notification message; and
rank the first plurality of non-urgent notification messages based on the combined metrics.

5. The assisted driving system of claim 4, wherein each of the combined metrics is generated based on a weighted sum of the corresponding risk mitigation metric and advantage gaining metric.

6. The assisted driving system of claim 4, wherein each of the combined metrics is generated based on a weighted harmonic mean of the corresponding risk mitigation metric and advantage gaining metric.

7. The assisted driving system of claim 1, wherein the ranking module is configured to rank the first plurality of non-urgent notification messages based on at least one of i) driver responses to the first plurality of non-urgent notification messages, and ii) previous driver responses to other non-urgent notification messages.

8. The assisted driving system of claim 1, further comprising an active learning module configured to actively learn driver preferences in outputting non-urgent notification messages based on driver responses to the first plurality of non-urgent notification messages,
wherein the assisted driving module is configured to output a second plurality of non-urgent notification messages based on the driver preferences.

9. The assisted driving system of claim 1, wherein the assisted driving module is configured to generate and output a second plurality of non-urgent notification messages based on at least one of driver responses and lack of driver responses to the outputting of the first plurality of non-urgent notification messages.

10. The assisted driving system of claim 1, wherein the assisted driving module is configured to display the first plurality of non-urgent notification messages via a plurality of displays.

11. The assisted driving system of claim 1, wherein the assisted driving module is configured to display a highest ranked one of the first plurality of non-urgent notification messages on a primary display and the other ones of the first plurality of non-urgent notification messages on a secondary display.

12. The assisted driving system of claim 1, wherein the assisted driving module is configured to determine which of the first plurality of non-urgent notification messages to display and at least one of i) not display a remainder of the first plurality of non-urgent notification messages, and ii) remove from memory the remainder of the first plurality of non-urgent notification messages.

13. The assisted driving system of claim 1, wherein the assisted driving module is configured to adjust saliency of the first plurality of non-urgent notification messages by adjusting at least one of a display order, colors, brightness levels, animation, blinking rates, locations, and sizes of the first plurality of non-urgent notification messages.

14. The assisted driving system of claim 1, wherein the assisted driving module is configured to re-rank at least one of the first plurality of non-urgent notification messages and a second plurality of non-urgent notification messages to modify which non-urgent notification messages are outputted for a driver and saliencies of each of the outputted non-urgent notification messages.

15. The assisted driving system of claim 1, wherein the telematics data includes vehicle-to-vehicle and cloud-based data.

16. The assisted driving system of claim 1, wherein the first plurality of non-urgent notification messages are outputted via at least one of a display, an audio device, and a haptic device.

17. An assisted driving method comprising:
receiving at an assisted driving module of host vehicle sensor data, telematics data, and driver response data;
based on the host vehicle sensor data and telematics data, generating a first plurality of non-urgent notification messages;
ranking the first plurality of non-urgent notification messages based on the driver response data; and
based on the ranking of the first plurality of non-urgent notification messages, outputting via at least one output device the first plurality of non-urgent notification messages such that saliency of each of the first plurality of non-urgent notification messages is based on the respective ranking of that non-urgent notification message.

18. The assisted driving method of claim 17, further comprising:
generating a respective risk mitigation metric and a respective advantage gaining metric for each of the first plurality of non-urgent notification messages; and
ranking the first plurality of non-urgent notification messages based on the risk mitigation metrics and the advantage gaining metrics.

19. The assisted driving method of claim 17, further comprising ranking the first plurality of non-urgent notification messages based on at least one of i) driver responses to the first plurality of non-urgent notification messages, and ii) previous driver responses to other non-urgent notification messages.

20. The assisted driving method of claim 17, further comprising, based on the ranking of the first plurality of non-urgent notification messages, adjusting saliency of the first plurality of non-urgent notification messages by adjusting at least one of display order, color, brightness, animation, blinking rate, location, and size of the first plurality of non-urgent notification messages.
